(19) United States
(12) Patent Application Publication
(10) Pub. No.: US 2016/0188035 A1
(43) Pub. Date: Jun. 30, 2016

(54) TOUCH PANEL

(71) Applicant: Chunghwa Picture Tubes, LTD., Taoyuan City (TW)

(72) Inventors: Chui-Xiang Chiou, Taoyuan City (TW); Ming-Chi Weng, Kinmen County (TW)

(21) Appl. No.: 14/623,493

(22) Filed: Feb. 16, 2015

(30) Foreign Application Priority Data
Dec. 26, 2014 (TW) 103145720

(51) Int. Cl. G06F 3/044

(52) U.S. Cl. CPC G06F 3/044

(57) ABSTRACT

A touch panel including a substrate having an active region and a bonding region and a patterned conductive layer disposed on the substrate. The active region includes electrode regions and signal transmission regions alternately arranged. The patterned conductive layer includes first sensing units, second sensing units and signal transmission lines. Each first sensing unit is located in one electrode region, each second sensing unit is located in one signal transmission region and the signal transmission lines are located in the signal transmission regions and extended into the bonding region. Each first sensing unit is used for performing a mutual-capacitive touch sensing and includes at least one scan electrode and readout electrodes. Each second sensing unit is used for performing a self-capacitive touch sensing and formed by a bar-like electrode. Each transmission line is connected to one readout electrode.

### CROSS-REFERENCE TO RELATED APPLICATION

This application claims the priority benefit of Taiwan application serial no. 103145720, filed on Dec. 26, 2014. The entirety of the above-mentioned patent application is hereby incorporated by reference herein and made a part of this specification.

### TECHNICAL FIELD

The invention relates to a touch panel, and more particularly to a single layer electrode type touch panel.

### RELATED ART

In the current information era, human beings by degrees tend to rely increasingly on electronic products. The electronic products such as mobile phones, handheld personal computers (PCs), personal digital assistants (PDAs) and smart phones have pervaded everywhere in our daily life. To meet current demands on portable, compact, and user-friendly information technology (IT) products, touch panels have been introduced as input devices in replacement of conventional keyboards or mice. Among the touch panels, a touch display panel capable of performing both a touch sensing function and a display function is one of the most popular products at present.

As to the types of touch panels, the touch panels may be divided into a single layer electrode structure and a double layer electrode structure according to the arrangement of the electrodes. Although a design with single layer electrode structure may achieve the thinness requirement and save on manufacturing costs, this type of design requires placement of the sensing electrodes and the transmission lines in the predetermined operating regions, such that the regions preconfigured with the transmission lines cannot provide a sensing function. Therefore, with the design of the single layer electrode structure, a sensed touch track typically has poor linearity.

### SUMMARY OF THE INVENTION

The invention provides a touch panel having an ideal touch sensing function.

The invention provides a touch sensing method having an ideal signal measuring continuity.

The invention provides a touch panel including a substrate and a patterned conductive layer disposed on the substrate. The active region includes a plurality of electrode regions and a plurality of signal transmission regions, and the electrode regions and the signal transmission regions are alternately arranged. The patterned conductive layer includes a plurality of first sensing units, a plurality of second sensing units, and a plurality of signal transmission lines. Each of the first sensing units is located in one of the electrode regions, each of the second sensing units is located in one of the signal transmission regions, and the signal transmission lines are located in the signal transmission regions and extended into the bonding region. Each of the first sensing regions is used for performing a mutual-capacitive touch sensing and includes at least one scan electrode and a plurality of readout electrodes. Each of the second sensing units is used for performing a self-capacitive touch sensing and is formed by a bar-like electrode. Each of the signal transmission lines is connected to one of the readout electrodes.

According to an embodiment of the invention, each of the scan electrodes has a main part and a plurality of branch parts extending from the main part to form a comb pattern, and each of the readout electrodes is located between two neighboring branch parts.

According to an embodiment of the invention, the first sensing units, the second sensing units, and the signal transmission lines do not overlap each other.

According to an embodiment of the invention, in a same one of the signal transmission regions, the signal transmission line closer to the second sensing units has a longer width.

According to an embodiment of the invention, the bar-like electrode forming each of the second sensing units has a plurality of parts, and a part closer to the bonding region has a smaller width.

According to an embodiment of the invention, the bar-like electrode forming each of the second sensing units has a variable width, and the variable width gradually increases outwards from the bonding region.

According to an embodiment of the invention, each of the second sensing units has a ladder shape.

According to an embodiment of the invention, in a same one of the signal transmission regions, the closer to the bonding region, the more signal transmission lines are disposed.

The invention provides a touch sensing method, including providing the afore-described touch panel and after a touch signal is generated, and determining whether the touch signal has been generated by one of the second sensing units. When the touch signal has been generated by one of the second sensing units, the self-capacitive touch sensing is performed with the second sensing unit generating the touch signal. When the touch signal has not been generated by one of the second sensing units, the mutual-capacitive touch sensing is performed with the first sensing unit generating the touch signal.

According to an embodiment of the invention, when the touch signal is determined to not be generated by one of the second sensing units, the second sensing units are connected to a ground potential.

According to an embodiment of the invention, the self-capacitive touch sensing includes determining whether a user touch location is closer to the bonding region or farther away from the bonding region according to a magnitude of a signal read.

In summary, the touch panel according to embodiments of the invention can achieve ideal sensing quality. In particular, when the touch location spans the signal transmission regions, the touch panel can still accurately sense the touch location.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a partial schematic top view of a touch panel according to an embodiment of the invention.

FIG. 2 is a flow diagram of a touch sensing method of a touch panel according to an embodiment of the invention.

FIG. 3 is a partial schematic top view of a touch panel according to an embodiment of the invention.

### DETAILED DESCRIPTION OF DISCLOSED EMBODIMENTS

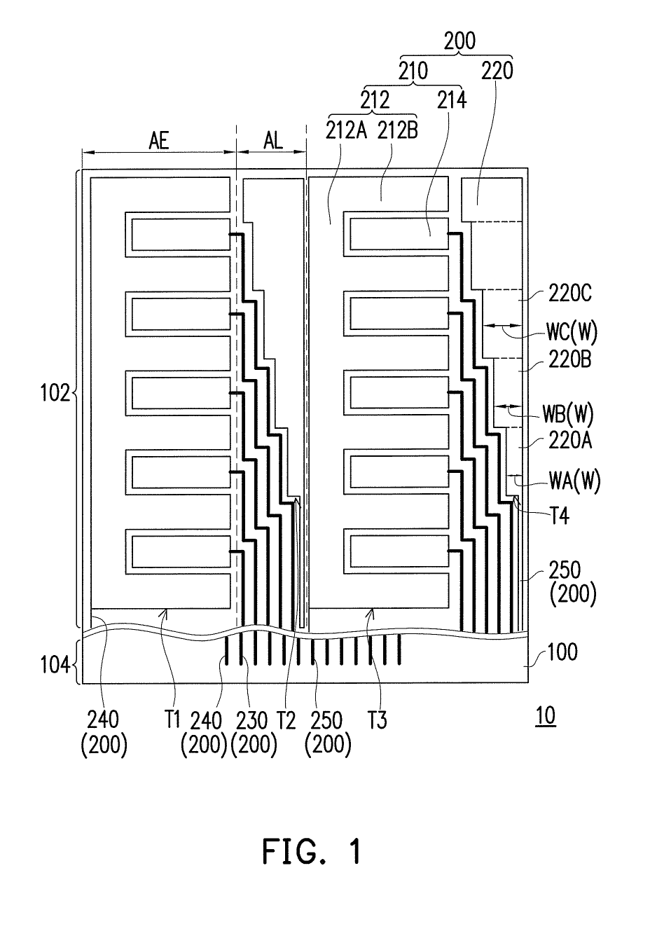

FIG. 1 is a partial schematic top view of a touch panel according to an embodiment of the invention. With reference to FIG. 1, a touch panel 10 includes a substrate 100 and a patterned conductive layer 200. The substrate 100 includes an active region 102 and a bonding region 104 located on one side of the active region 102. The active region 102 includes a plurality of electrode regions AE and a plurality of signal transmission regions AL, and the electrode regions AE and the signal transmission regions AL are alternately arranged. The patterned conductive layer 200 is disposed on the substrate 100, and the patterned conductive layer 200 includes a plurality of first sensing units 210, a plurality of second sensing units 220, and a plurality of signal transmission lines 230. Each of the first sensing units 210 is located in one of the electrode regions AE, each of the second sensing units 220 is located in one of the signal transmission regions AL, and the signal transmission lines 230 are located in the signal transmission regions AL and extended into the bonding region 104. Each of the first sensing regions 210 is used for performing a mutual-capacitive touch sensing and includes at least one scan electrode 212 and a plurality of readout electrodes 214, and each of the second sensing units 220 is used for performing a self-capacitive touch sensing and is formed by a bar-like electrode.

In specifics, since the patterned conductive layer 200 is formed by patterning a single conductive layer, therefore, the first sensing units 210, the second sensing units 220, and the signal transmission lines 230 may be fabricated by a same patterning step (e.g. lithography and etching, laser marking, or other patterning steps). In other embodiments, the first sensing units 210, the second sensing units 220, and the signal transmission lines 230 may also be fabricated by a printing process, and these elements may be fabricated by one printing step. Therefore, the sensing units 210, the second sensing units 220, and the signal transmission lines 230 do not overlap each other. In other words, the touch panel 10 is a single layer electrode type touch panel.

In the present embodiment, each of the scan electrodes 212 has a main part 212A and a plurality of branch parts 212B extending from the main part 212A to form a comb pattern. Each of the readout electrodes 214 is located between two neighboring branch parts 212B. When the touch panel 10 performs a touch sensing, a scan signal is inputted into the scan electrodes 212 of the first sensing units 210, so that a read can be performed on the readout electrodes 214 corresponding to the scan electrodes 212. The touch panel 10 may determine whether a touch operation exists and a touch point location according to a signal read by the readout electrodes 214.

In order to implement signal transmission, each of the signal transmission lines 230 is connected to one of the readout electrodes 214, and an end of each of the signal transmission lines 230 is located in the bonding region 104 of the substrate 100. Accordingly, by bonding a circuit board (not drawn) configured with a touch control circuit or bonding a drive chip into the bonding region 104, signal connectivity can be achieved between the first sensing units 210 and the touch control circuit. In the present embodiment, the scan electrodes 212 and the readout electrodes 214 in the first sensing units 210 are formed patterning a same conductive layer, and therefore the scan electrodes 212 and the readout electrodes 214 in the first sensing units 210 do not overlap each other.

Each of the readout electrodes 214 needs one signal transmission line 230 to transmit signals, and the signal transmission lines 230 connected to the readout electrodes 214 in each of the first sensing units 210 extend outwards in a same direction. Therefore, in a same signal transmission region AL, the signal transmission line 230 closer to the second sensing units 220 has a longer width. Moreover, the closer to the bonding region 104, the greater a layout quantity of the signal transmission lines 230. Therefore, as the bonding region 104 is approached, the signal transmission lines 230 require a larger layout width.

In the present embodiment, the second sensing units 220 formed by bar-like electrodes may have a variable width W. When the second sensing units 220 are divided into a plurality of sections 220A, 220B, 220C, . . . , and the section 220A is closer to the bonding region 104 than the section 220B, then a width WA of the section 220A is smaller than a width WB of the section 220B. Similarly, the section 220B is closer to the bonding region 104 compared to the section 220C, and thus the width WB of the section 220B is smaller than a width WC of the section 220C. In other words, the closer to the bonding region 104, the smaller the value of the variable width W. In the present embodiment, the second sensing units 220 formed by bar-like electrodes has a ladder shape, although the invention is not limited thereto. In other embodiments, the second sensing units 220 may have a trapezoidal shape, and the variable width W may gradually increase outwards from the bonding region 104.

In the present embodiment, besides using the signal transmission lines 230 to transmit the signals of the readout electrodes, the signal transmission lines 240 are configured to transmit the signals of the scan electrodes 212, and the signal transmission lines 250 are configured to transmit the signals of the second sensing units 220. The signal transmission lines 240 and 250 are extended into the bonding region 104, so that the second sensing units 220 and the scan electrodes 212 are signal connected to the touch control circuit (not drawn).

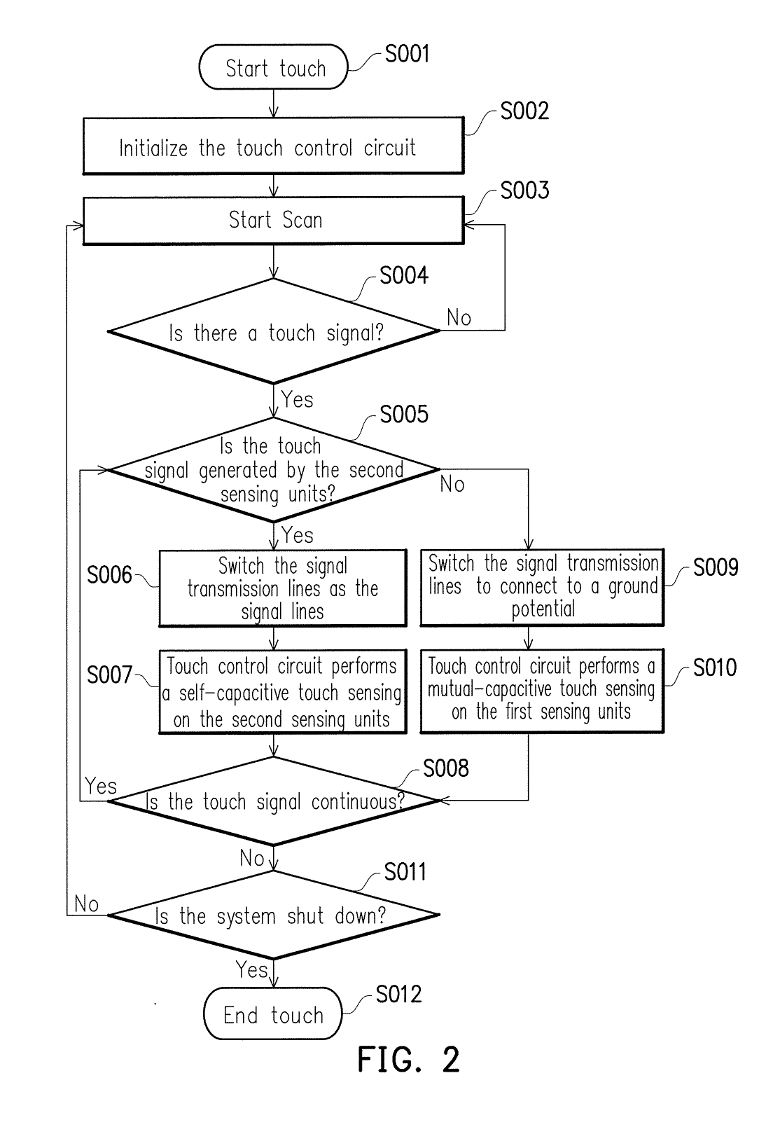

FIG. 2 is a flow diagram of a touch sensing method of a touch panel according to an embodiment of the invention. With reference to FIG. 1 and FIG. 2, a touch sensing method of the touch panel 10 includes after receiving a touch control message (Step S001), initializing the touch control circuit (Step S002). Thereafter, a scan is performed under the control of the control circuit (Step S003). At this time, for the substrate 100 depicted in FIG. 1, when a first sensing unit 210, a second sensing unit 220, another first sensing units 210, and another second sensing unit 220 are respectively represented by a sensing unit T1, a sensing unit T2, a sensing unit T3, and a sensing unit T4, the sensing unit T1, the sensing unit T2, the sensing unit T3, and the sensing unit T4 are sequentially scanned in Step S003. In Step S004, whether a touch signal has been generated during the scan is then determined. When Step S004 determined that a touch signal has been generated, Step S005 may be executed to determine whether the touch signal has been generated by the second sensing units 220, which is the sensing unit T2 or the sensing unit T4. When Step S004 determined that no touch signal has been generated, the process returns to Step S003 to continue scanning.

When Step S005 determined that the touch signal is generated by the second sensing units 220, the signal transmission lines 250 may be switched as the signal lines connected to the touch control circuit (Step S006), and Step S007 is executed, in which the touch control circuit performs a self-capacitive touch sensing in order to use a signal read by the corresponding second sensing units 220 to determine a touch location. In other words, Step S007 puts the touch control circuit in a self-capacitive sensing mode to determine the touch location corresponding to the signal read by the second sensing units 220. After determining the touch location, Step S008 may be executed to determine whether the touch signal has continued to occur. When Step S008 determined that the touch signal has continued to occur, the process returns to Step S005.

Moreover, in Step S005, when the touch signal is determined to not be generated by the second sensing units 220, then Step 5009 is executed to switch the signal transmission lines 250 to connect to a ground potential. In addition, Step S010 is executed, in which the touch control circuit performs a mutual-capacitive touch sensing to determine the touch location. After Step S010 determines the touch location, Step S008 may be executed to determine whether the touch signal has continued to be generated. When Step S008 determined that the touch signal has continued to be generated, the process returns to Step S005 to continue performing the touch sensing.

When Step S008 determined that no touch signal has continued to occur, Step S011 may be executed to determine whether a system has been shut down. When the system has not been shut down, Step S003 is executed. When the system has been shut down, then the touch sensing is terminated (Step S012).

In the present embodiment, since the second sensing units 220 have the variable width W, therefore, when a user touches different parts of the second sensing units 220, different values of the touch signal may be generated. Accordingly, the touch control circuit may determine whether the user touch location is closer to the bonding region 104 or far away from the bonding region 104 according to a magnitude of the signal read by the second sensing units 220 in Step S007. In other words, not only can the second sensing units 220 determine whether a touch operation has occurred, but the second sensing units 220 may also determine the touch location. Therefore, the touch panel 10 can achieve a preferable sensing linearity and provide an ideal touch sensing function.

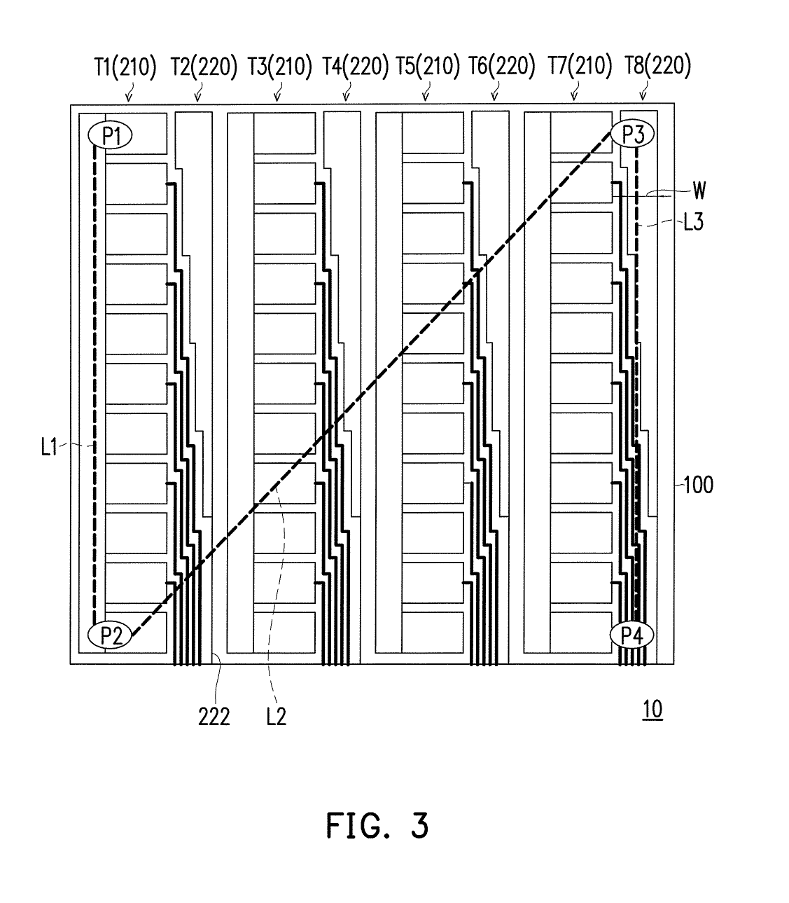

FIG. 3 is a partial schematic top view of a touch panel according to an embodiment of the invention. With reference to FIG. 3, the structural design of the touch panel 10 may be obtained in reference to FIG. 1 and its related description, and therefore further elaboration thereof is omitted hereafter. In FIG. 3, eight sets of sensing units T1-T8 are disposed on the touch panel 10, in which the sensing units T1, T3, T5, and T7 are respectively the first sensing units 210, and the sensing units T2, T4, T6, and T8 are respectively the second sensing units 220.

In FIG. 3, the user may perform a touch operation along the touch paths L1, L2, and L3, for example. In other words, the user starts the touch operation from a touch point P1, moves the touch location to a touch point P2 along the touch path L1, moves to a touch point P3 along the touch path L2, and finally moves to a touch point P4 along the touch path L3 from the touch point P3.

As shown in FIG. 2 and FIG. 3, when the user touches the touch point P1, the sensing unit T1 generates the touch signal, and accordingly Step S004 determines that a signal has been generated, and Step S005 is executed. However, since the sensing unit T1 is the first sensing unit 210, after the determination of Step S005, Step S009 and Step S010 are executed. Thereafter, when the user performs the touch along the touch path L1, the sensing unit T1 continues to generate the touch signal, and therefore, after the determination of Step S008, Step S005 is executed. At this time, since the touch signal is still generated by the sensing unit T1 (first sensing unit 210), Step S009, Step S010, and Step S008 are executed until the user touches the touch point P2.

When the user touches along the touch path L2 from the touch point P2 and a touch area overlaps the sensing unit T2, Step S005 determines that the touch signal is generated by the second sensing units 220, and the corresponding signal transmission lines 250 are switched as the signal lines (Step S006). At this time, the touch control circuit executes Step S007 to determine the touch location. Thereafter, after the determination of Step S008, since the user continues to touch along the touch path L2, the touch control circuit executes Step S005 again.

When the touch operation follows the touch path L2 from the touch point P2 and the touch area overlaps the sensing units T3, T5, and T7, after the determination of Step S005, the touch control circuit executes Step S009 and Step S010. Thereafter, when the user touches along the touch path L2 from the touch point P2 and the touch area overlaps the sensing units T4, T6, and T8, after the determination of Step S005, the touch control circuit executes Step S006, Step S007, and Step S008. Moreover, when the user touches along the touch path L3 from the touch point P3 to the touch point P4, after the determination of Step S005, the touch control circuit executes Step S006, Step S007, and Step S008.

In the present embodiment, since the second sensing units 220 have the variable width W, therefore, when the user touches along the touch path L3 from the touch point P3 to the touch point P4, a signal sensed by the sensing unit T8 is related to a magnitude of the variable width W. Accordingly, the touch control circuit may use the magnitude of the signal read to determine which part of the second sensing units 220 the touch location is positioned. Similarly, when the touch point overlaps the sensing units T2, T4, T6, and T6, since the second sensing units 220 have the variable width W, the touch control circuit may use the magnitude of the signal received to determine whether the touch location is closer to the bonding region or farther away from the bonding region. Therefore, when the touch operation follows the touch path L2, the touch panel 10 can also accurately determine the touch track.

In view of the foregoing, in the touch panel according to embodiments of the invention, the mutual-capacitive sensing units and the self-capacitive sensing units are alternately arranged, and the self-capacitive sensing units are disposed in the signal transmission regions. Therefore, the signal transmission regions may also provide the touch sensing function. Accordingly, the touch panel in the embodiments of the invention may achieve ideal sensing quality. In particular, when the touch location spans the signal transmission regions, the touch panel can still accurately sense the touch location.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch panel, comprising:
a substrate having an active region and a bonding region located on one side of the active region, wherein the active region comprises a plurality of electrode regions and a plurality of signal transmission regions, and the electrode regions and the signal transmission regions are alternately arranged; and
a patterned conductive layer disposed on the substrate, the patterned conductive layer comprising a plurality of first sensing units, a plurality of second sensing units, and a plurality of signal transmission lines, each of the first sensing units being located in one of the electrode regions, each of the second sensing units being located in one of the signal transmission regions, the signal transmission lines being located in the signal transmission regions and extending into the bonding region, wherein each of the first sensing regions is used for performing a mutual-capacitive touch sensing and comprises at least one scan electrode and a plurality of readout electrodes, each of the second sensing units is used for performing a self-capacitive touch sensing and is formed by a bar-like electrode, and each of the signal transmission lines is connected to one of the readout electrodes.

2. The touch panel according to claim 1, wherein each of the scan electrodes has a main part and a plurality of branch parts extending from the main part to form a comb pattern, and each of the readout electrodes is located between two neighboring branch parts.

3. The touch panel according to claim 1, wherein the first sensing units, the second sensing units, and the signal transmission lines do not overlap each other.

4. The touch panel according to claim 1, wherein in a same one of the signal transmission regions, the signal transmission line closer to the second sensing units has a longer width.

5. The touch panel according to claim 1, wherein the bar-like electrode forming each of the second sensing units has a plurality of parts, and a part closer to the bonding region has a smaller width.

6. The touch panel according to claim 1, wherein the bar-like electrode forming each of the second sensing units has a variable width, and the variable width gradually increases outwards from the bonding region.

7. The touch panel according to claim 1, wherein each of the second sensing units has a ladder shape.

8. The touch panel according to claim 1, wherein in a same one of the signal transmission regions, the closer to the bonding region, the more signal transmission lines are disposed.

9. A touch sensing method, comprising:
providing the touch panel of claim 1; and
after a touch signal is generated, determining whether the touch signal has been generated by the second sensing units, and when the touch signal has been generated by one of the second sensing units, performing the self-capacitive touch sensing with the second sensing unit generating the touch signal; when the touch signal has not been generated by the second sensing units, performing the mutual-capacitive touch sensing with the first sensing unit generating the touch signal.

10. The touch sensing method according to claim 9, wherein when the touch signal is determined to not be generated by the second sensing units, connecting the second sensing units to a ground potential.

11. The touch sensing method according to claim 9, wherein the self-capacitive touch sensing comprises determining whether a user touch location is closer to the bonding region or farther away from the bonding region according to a magnitude of a signal read.
